(19) United States
(12) Patent Application Publication
(10) Pub. No.: US 2025/0314275 A1
(43) Pub. Date: Oct. 9, 2025

(54) RAILWAY BRAKING SYSTEM FOR A RAILWAY VEHICLE, AND RAILWAY VEHICLE PROVIDED WITH SUCH A SYSTEM

(71) Applicant: WABTEC Hauts-de-France, Amiens (FR)

(72) Inventors: Denis Gerber-Papin, L'Etoile (FR); Damien Beauvois, Amiens (FR); Claudino Goncalves, Ribeaucourt (FR)

(73) Assignee: WABTEC Hauts-de-France, Amiens (FR)

(21) Appl. No.: 18/864,934

(22) PCT Filed: May 12, 2023
(86) PCT No.: PCT/FR2023/050688

§ 371 Date: Nov. 12, 2024

(30) Foreign Application Priority Data
May 13, 2022 (FR) 2204568

(51) Int. Cl. F16D 55/224; B61H 5/00; B61H 13/38; F16D 55/00; F16D 65/00; F16D 65/18; F16D 125/68

(52) U.S. Cl. CPC F16D 55/2245; B61H 5/00; B61H 13/38; F16D 65/0056; F16D 65/18; F16D 2055/0008; F16D 2125/68

(57) ABSTRACT

The invention relates to a railway braking system comprising a connection device (7) having a lower part (14), an upper part (15) distinct from the lower part, two main posts (16) connecting the lower part to the upper part, and an attachment portion (18) forming a single anchor zone via which the system is configured to be mechanically secured to a railway vehicle, the system further comprising a brake linkage having levers (12) mounted with the ability to rotate about the two main posts, and a service and/or parking brake configured to act on the braking member as a result of actuation of the levers, with the connection device comprising at least one additional post (17) that also connects the lower part to the upper part and is positioned closer to the attachment portion than are the two main posts.

### TECHNICAL FIELD OF THE INVENTION

The invention relates to the field of railway vehicle braking. More particularly, it relates to a braking system for a railway vehicle with brakes with at least one lining, configured to act on a braking member of said railway vehicle via said at least one lining. It also relates to railway vehicles including such systems.

### PRIOR ART

So-called railway vehicles with brakes with at least one lining are generally equipped with brake systems with service and/or parking brake cylinders, including for example a piston movable under the effect of a pressurised fluid, the movement of this piston actuating a brake linkage and causing a braking action such as clasping of a brake disk by the lining of this linkage.

Such a braking system is mounted on the railway vehicle, so as to be in contact with the brake disks or with the wheels.

This braking system may be mechanically connected to a support formed directly or indirectly by a bogie, or by an axle fastened to the bogie, or by another device of the drive motor or gearbox type also mounted on the bogie.

The braking action generates forces which can be transmitted, via the levers and the connection device, to the support to which the braking system is connected.

In particular, in the case where the braking system is provided with force transmission connecting rods which are mechanically connected, on the one hand, to lining carriers and, on the other hand, to the support to which the braking system is connected, most of the forces can be transmitted to the support via the force transmission connecting rods.

On the contrary, in the case where the braking system is devoid of any force transmission connecting rod, for example for reasons related to the compactness of the braking system, then the forces can be transmitted, throughout the linkage from the lining holders towards movable levers, to the service and/or parking brake cylinders of the braking system and/or to a connector mechanically connected to the support to which the braking system is connected.

Application WO 2019/175164 A1 describes a railway braking system of the type with force transmission connecting rods. This system is provided with a connector having two vertical rods around which the movable levers are pivotably mounted which allow actuating the lining carriers and therefore the linings carried by the lining carriers to clasp a brake disk of a railway vehicle.

The connector is formed into two distinct parts and connected together by the two vertical rods. An upper part of the connector has an attachment head configured to mechanically connect the connector to the support formed directly or indirectly by the bogie, the axle or another component. It is specified that no additional part is necessary.

In application WO 2019/175164 A1, it is also indicated that, according to a non-illustrated variant, the system could be devoid of any connecting rod and the friction forces would then be transmitted by the connector.

### DISCLOSURE OF THE INVENTION

The invention relates to a railway braking system of the connecting rod-free type, having improved performance, while being simple, convenient and economical.

Thus, according to a first aspect, an object of the invention is a railway braking system for a railway vehicle with brakes with at least one lining, configured to act on at least one braking member of the railway vehicle via the at least one lining and including a connection device having a lower part, an upper part distinct from the lower part, two main posts connecting the lower part to the upper part and an attachment portion forming a single anchor zone by which the railway braking system is configured to be mechanically connected to the railway vehicle, the system further including a brake linkage having levers mounted movable in rotation about the two main posts, and a service and/or parking brake configured to act on the braking member by actuation of the levers of the brake linkage; characterised in that the connection device further includes at least one additional post also connecting the lower part to the upper part and which is arranged closer to the attachment portion than the two main posts.

The system according to the invention is a system without no connecting rods and its unique anchor point on a support of the railway vehicle takes place at the level of the connection device.

In the system according to the invention, the so-called friction forces that are generated when braking are transmitted by the two main posts and by the additional post to the connection device and in particular to its upper part and then to the support of the vehicle via the attachment portion of the connection device.

In other words, the main posts are not just axes around which the levers are movable in rotation but also, and above all, consist of force transmission members.

Furthermore, the main posts are supported by the at least one additional post which, because of its arrangement proximate to the attachment portion, ensures enough rigidity to the connection device and an optimum transmission of the forces in particular towards the attachment portion.

Indeed, the main posts are generally located in the same first vertical plane and the at least one additional post is located in a second vertical plane offset with respect to the first vertical plane and closer to the attachment portion.

Preferred, simple, convenient and economical features of the system according to the invention are set out hereinafter.

The upper part of the connection device extends generally longitudinally between a first end and a second end opposite to the first end, the main posts are mechanically connected respectively on a first side and on a second side opposite to the first side, at the level of the second end of the upper part, and the attachment portion extends longitudinally over a central zone of the connection device located between the first side and the second side, from the first end towards the second end.

A backup member, for example of the radial pin type, may be mounted on at least one end of at least one post to secure the assembly.

The upper part of the connection device is provided with a first arm extending from a main fastening upper zone of one of the two main posts, with a second arm extending from another main fastening upper zone of the other one of the main posts, with the first arm and the second arm each joining the attachment portion.

In particular, the first arm may extend from the second end on the first side towards the central zone, the second arm may extend from the second end on the second side towards the central zone where the attachment portion is located and an additional fastening upper zone of the additional post at the level of the second end.

In other words, the upper part of the connection device is solid, with the first arm and the second arm which join together at the level of the attachment portion, immediately proximate to the additional fastening upper zone of the additional post, without any void between these different elements.

The lower part of the connection device is generally C-like shaped and is provided with a main fastening lower zone formed at each free end of the C and with an additional fastening lower zone formed at the centre of the C.

The main posts and the at least one additional post are mechanically connected by screwing and/or by interlocking, optionally by shrink-fitting, and/or by welding and/or by gluing to the upper part and/or to the lower part of the connection device.

The railway braking system includes at least one repositioning member substantially elastic and having a first end connected to the upper part and a second end connected to a lining carrier on which at least one said lining is mounted.

The attachment portion of the connection device has at least one cylindrical wall and the railway braking system includes an anchor member formed by at least one base mounted opposite the cylindrical wall, a mounting rod inserted at least partially into the base and into the cylindrical wall, and at least one cylindrical ring mounted between the mounting rod and the base and/or between the mounting rod and the cylindrical wall, with the at least one base being pivotably mounted relative to the attachment portion.

The anchor member is provided with at least one cylindrical ring made for example of metal and mounted between the mounting rod and the base and with at least a cylindrical ring made for example of plastic or of metal and mounted between the mounting rod and the cylindrical wall.

The at least one base is positioned opposite at least one additional fastening upper zone of the additional post which is formed in the upper part of the connection device.

The anchor member is provided with at least one return member which is mounted so as to cooperate with both the at least one base and the upper part of the connection device and which has a stable position in which it biases the at least one base to return the connection device back to a predetermined position, for example substantially horizontally.

The at least one return member is formed by an elastic rod having a first free end mounted in an orifice formed in the at least one base, and a second free end opposite to the first free end and accommodated in a projection formed on the upper part of the connection device.

Another object of the invention is a railway vehicle with brakes with at least one lining, including at least one railway braking system as described hereinabove, configured to act on at least one braking member of said railway vehicle via said at least one lining.

### BRIEF DESCRIPTION OF THE FIGURES

The disclosure of the invention will now be carried on with the description of some embodiments, provided hereinafter as example and without limitation, with reference to the appended drawings.

FIG. 1 partially illustrates, in side view, a railway vehicle provided with a railway braking system acting on a brake disk of the railway vehicle via linings.

FIG. 2 is similar to FIG. 1, showing the vehicle in top view.

FIG. 3 is similar to FIG. 1, showing the vehicle in bottom view.

FIG. 4 is an isolated perspective view of the railway braking system visible in FIGS. 1 to 3.

FIG. 5 is similar to FIG. 4, showing the railway braking system according to a different view angle.

FIG. 6 shows the railway braking system only partially and in exploded perspective view.

FIG. 7 is an isolated and partially disassembled perspective view of a connection device of the railway braking system.

FIG. 8 is a sectional view of the connection device of the railway braking system.

### DETAILED DESCRIPTION

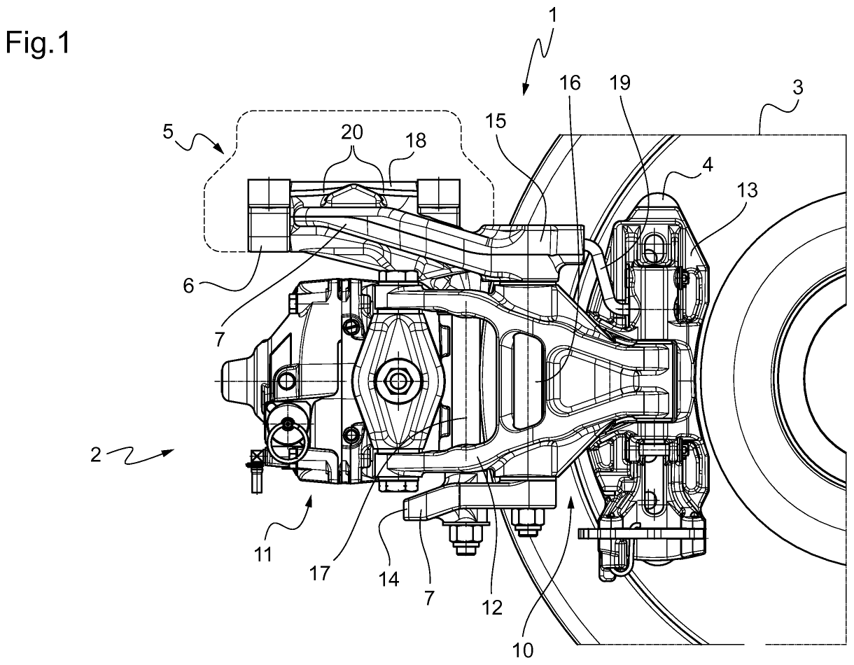

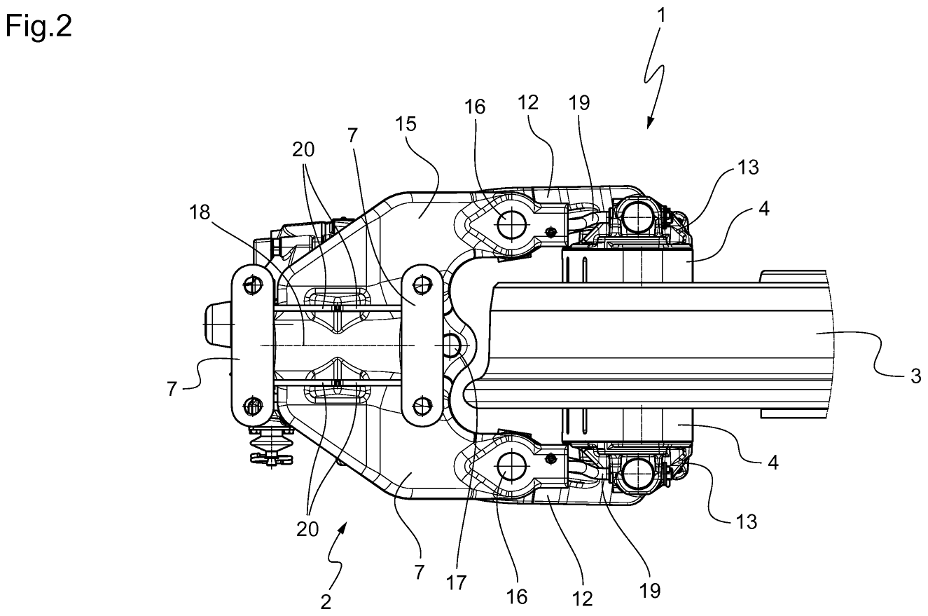

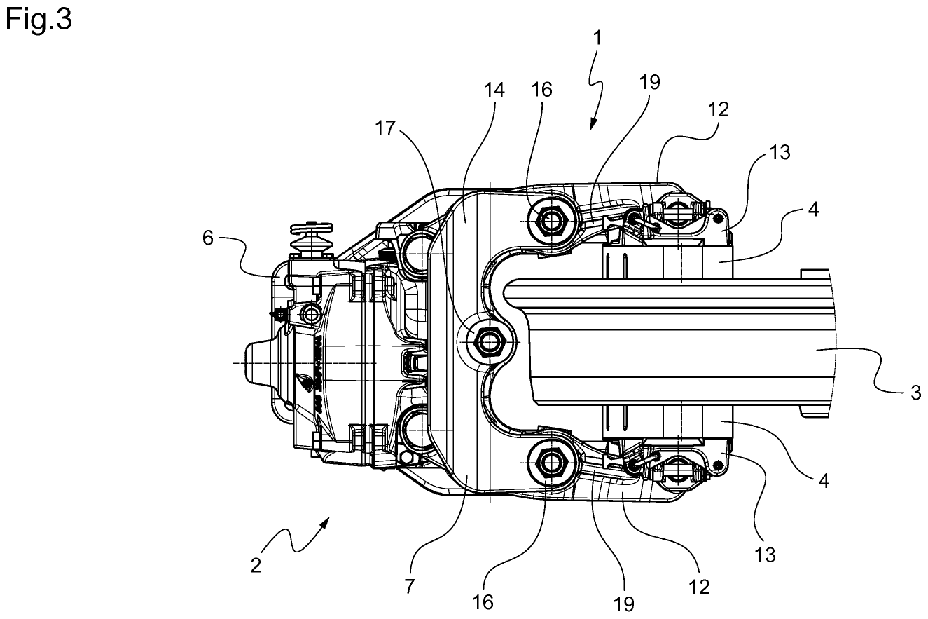

FIGS. 1 to 3 partially illustrate a railway vehicle 1 provided with a railway braking system 2 herein configured to act on a brake disk 3 of the railway vehicle 1 via linings 4.

The railway braking system 2 is mechanically connected to a support 5, which may be formed directly or indirectly by a bogie, or by an axle support fastened to the bogie, or by another device of the drive motor or gearbox type also mounted on the bogie.

Because of the movements inherent to the railway vehicle 1 both in the rolling phase and in the braking or brake release phase, the railway braking system 2 is mounted with the possibility of pivoting relative to the support 5.

The railway braking system 2 is herein mechanically connected to the railway vehicle 1 only via the support 5, throughout an anchor member 6 and a connection device 7 of the railway braking system 2 (described hereinafter in more detail).

In other words, this consists of a railway braking system 2 without any connecting rod and its unique anchor point on the support 5 of the railway vehicle 1 takes place at the level of the connection device 7 and of the anchor member 6.

The braking action generates braking forces which are therefore transmitted to the railway vehicle 1 only throughout the support 5 and via the connection device 7 and the anchor member 6.

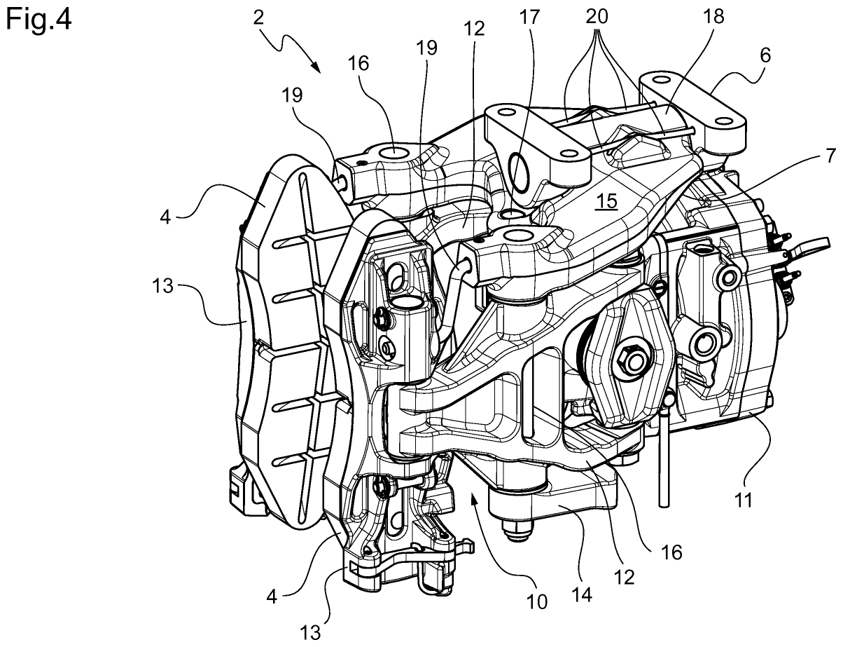

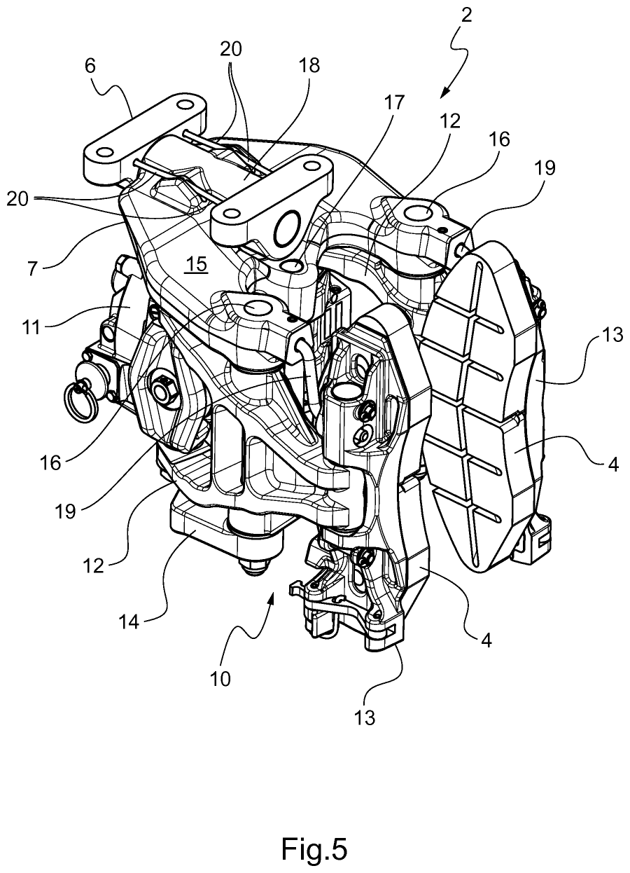

Referring to FIGS. 1 to 3 and also to FIGS. 4 and 5, which show the railway braking system 2 in particular with the anchor member 6, but without the support or the brake disk of the vehicle, the railway braking system 2 includes a brake linkage 10 and a service and/or parking brake 11 configured to act on the brake disk 3 via the brake linkage 10.

The service and/or parking brake 11 conventionally includes a cylinder, herein a pneumatic type cylinder.

The brake linkage 10 is provided with movable levers 12 mechanically connected at one end to the cylinder of the service and/or parking brake 11, and with lining carriers 13 which are mechanically connected to a respective opposite end of the levers 12 and which carry the linings 4.

The movable levers 12 are configured so as to be actuated by the service and/or parking brake 11.

The connection device 7 includes a lower part 14 and an upper part 15 distinct from the lower part 14.

The connection device 7 further includes two main posts 16 which connect the lower part 14 to the upper part 15 and around which the levers 12 are movably mounted.

Hence, the service and/or parking brake 11 is herein connected to the support 5 via the levers 12 which are pivotably carried by the connection device 7.

The connection device 7 further includes an additional post 17 also connecting the lower part 14 to the upper part 15.

In the illustrated example, the main posts 16 are generally located in the same first vertical plane and the additional post 17 is located in a second vertical plane offset with respect to the first vertical plane.

The connection device 7 further includes an attachment portion 18 forming one single anchor zone by which the railway braking system 2 is configured to be mechanically connected to the support 5 of the railway vehicle 1.

The additional post 17 is arranged closer to the attachment portion 18 than the two main posts 16.

The railway braking system 2 further includes repositioning members 19 substantially elastic and each having a first end connected to the upper part 15 of the connection device 7 and a second end connected to one of the respective lining carriers 13.

These repositioning members 19 allow biasing the lining carriers 13 in a generally vertical position and at least in a plane substantially parallel to that of the brake disk 3.

Furthermore, the anchor member 6 is provided with return members herein formed by elastic rods 20, herein made of metal and for example prestressed, which are mounted so as to cooperate with the upper part 15 of the connection device 7 and which have a stable position in which they bias the anchor member 6 and/or the connection device 7 to return the latter back into a predetermined position, for example substantially horizontally.

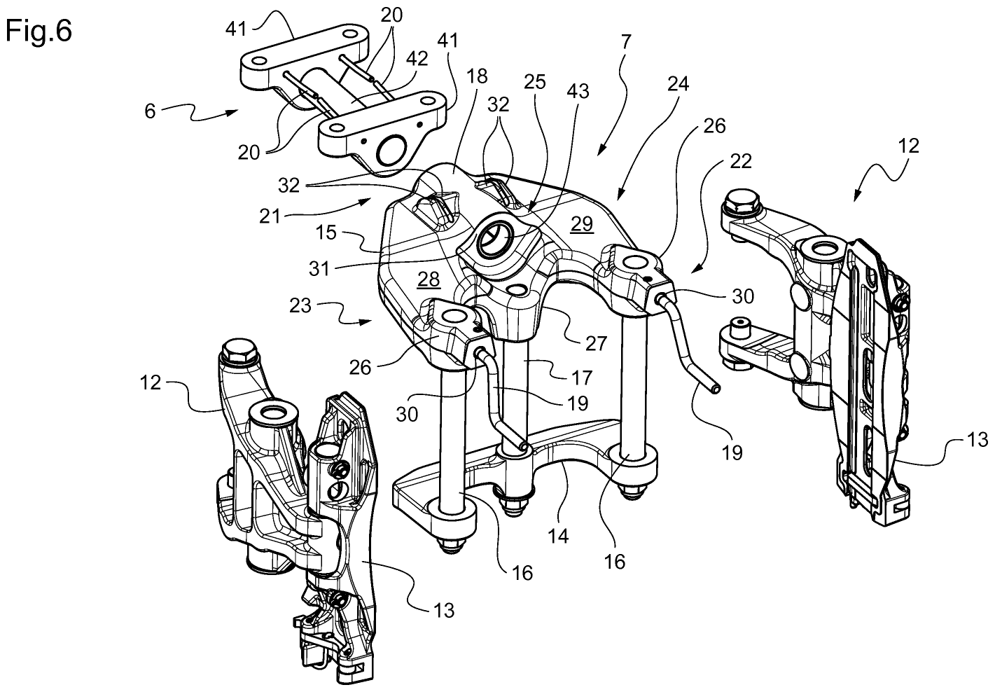

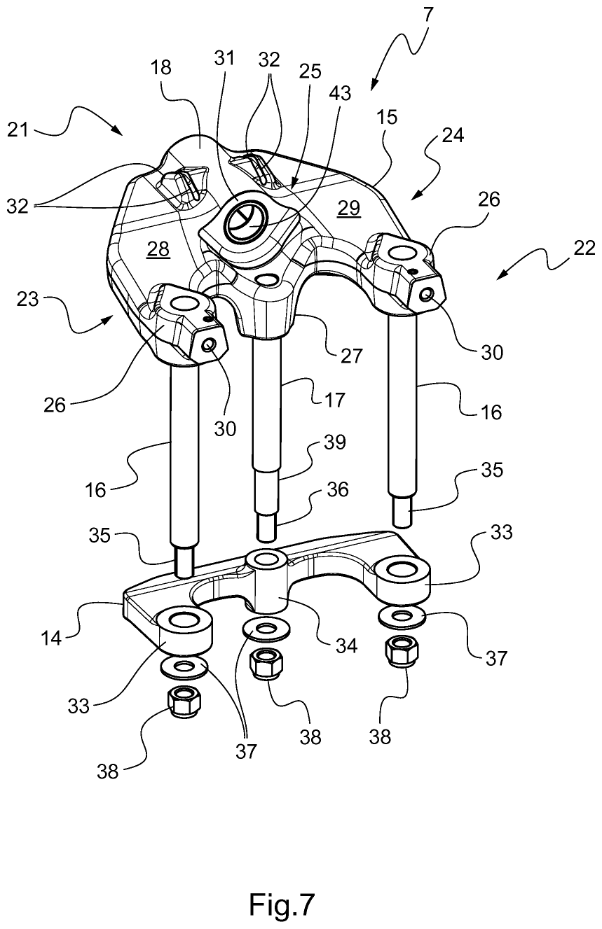

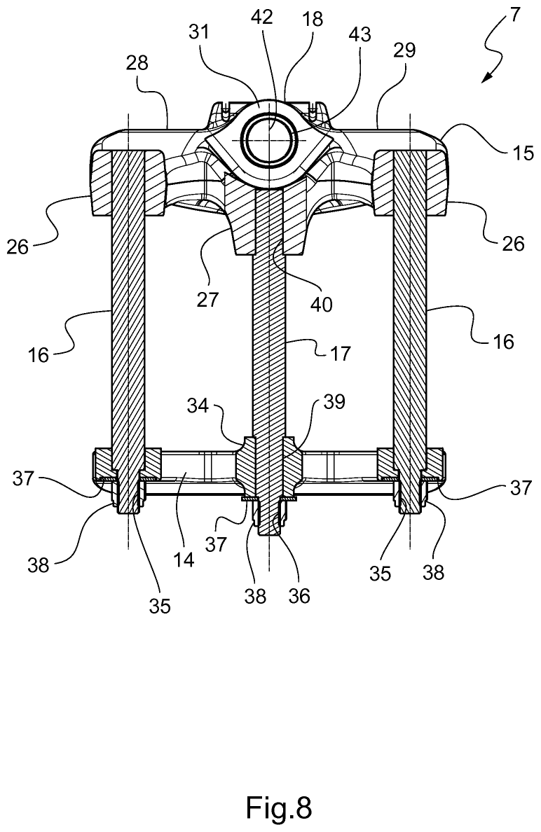

Referring in particular to FIGS. 6 to 8, the upper part 15 of the connection device 7 extends generally longitudinally between a first end 21 and a second end 22 opposite to the first end 21.

The main posts 16 are mechanically connected respectively to a first side 23 and to a second side 24 opposite to the first side 23, at the level of main fastening upper zones 26 formed at the second end 22 of the upper part 15.

The additional post 17 is mechanically connected at the level of an additional fastening upper zone 27 formed on a central zone 25 located between the first side 23 and the second side 24 and herein to the second end 22 of the upper part 15.

The attachment portion 18 extends longitudinally over the central zone 25 from the first end 21 towards the second end 22.

The upper part 15 of the connection device 7 is provided with a first arm 28 extending from a first one amongst the main fastening upper zones 26 of one of the two main posts 16, and with a second arm 29 extending from a second one amongst the main fastening upper zones 26 of the other one of the main posts 16.

Each of the first arm 28 and the second arm 29 joins the attachment portion 18 at the level of the central zone 25.

In particular, the first arm 28 extends from the second end 22 on the first side 23 towards the central zone 25, and the second arm 29 extends from the second end 22 on the second side 24 towards the central zone 25.

In other words, each of the first arm 28 and the second arm 29 extends towards the attachment portion 18 and the additional fastening upper zone 27 of the additional post 17.

What is more, the upper part 15 of the connection device 7 is solid, without any material void between the first arm 28, the second arm 29, the attachment portion 18 and the additional fastening upper zone 27 of the additional post 17.

Orifices 30 are formed in the upper part 15 of the connection device 7, at the level of the main fastening upper zones 26 at the second end 22, for mounting the substantially elastic repositioning members 19 by their respective first end.

In the illustrated example, the attachment portion 18 of the connection device 7 has a longitudinal cylindrical wall 31 formed on the central zone 25 at the junction of the first and second arms 28 and 29.

In the illustrated example, projections 32 are also formed on the upper part 15 of the connection device 7 on either side of the longitudinal cylindrical wall 31 of the attachment portion 18.

In particular, the projections 32 are herein defined by substantially vertical walls arranged opposite each other and thereby forming a space for receiving at least one end of a rod 20 (cf. hereinafter). It is in this receiving space that the rod is prestressed for example.

The lower part 15 of the connection device 7 herein has a C-like general shape.

The lower part 15 is provided with a main fastening lower zone 33 formed at each free end of the C for mechanically connecting the main posts 16, and with an additional fastening lower zone 34 formed at the centre of the C for mechanically connecting the additional post 17.

In the illustrated example, the main posts 16 and the additional post 17 are mechanically connected by screwing respectively to the main fastening lower zones 33 and to the additional fastening lower zone 34 on the lower part 14 of the connection device 7, and by interlocking by shrink-fitting on the main upper zones 26 and on the additional upper zone 27 on the upper part 15 of the connection device 7.

In particular, the main posts 16 and the additional post 17 are herein provided with a thinned lower portion 35, 36 which is threaded and which has passed respectively throughout the main fastening lower zones 33 and the additional fastening lower zone 34.

A washer 37 and a nut 38 are mechanically connected to each of the thinned lower portions 35, 36.

Screwing of the main posts 16 and of the additional post 17 with the lower part 14 of the connection device 7 enables quite easy disassembly and reassembly of the service brake and/or of the parking brake 11 together with the levers 12.

In the illustrated example, the additional post 17 also has, on the one hand, a thinned intermediate portion 39 which passes throughout the additional fastening lower zone 34, which has a thickness larger than that of the main fastening lower zones 33 and, on the other hand, a thinned upper portion 40 which passes throughout the additional fastening upper zone 27, which has a thickness larger than that of the main fastening upper zones 26.

In the illustrated example, the main posts 16 are devoid of such a thinned intermediate portion and of such a thinned upper portion.

The anchor member 6 is herein formed by two bases 41 mounted at each end of the cylindrical wall 31 of the attachment portion 18, and a mounting rod 42 inserted at least partially into each base 41 and into the cylindrical wall 31.

The bases 41 and the mounting rod 42 are pivotably mounted relative to the cylindrical wall 31 and therefore relative to the attachment portion 18.

In the illustrated example, one of the two bases 41 is located adjacent to the upper part 15 at the level of its first end 21, whereas the other one of the two bases 41 is positioned above the upper part 15 and opposite the additional fastening upper zone 27 of the additional post 17.

The anchor member 6 further includes one or more cylindrical ring(s) 43 mounted between the mounting rod 42 and the cylindrical wall 31.

The anchor member 6 may also include one or more cylindrical ring(s) (not shown) mounted between the mounting rod 42 and the bases 41.

The ring(s) mounted between the mounting rod 42 and the cylindrical wall 31 may be made, for example, of metal or plastic, whereas the ring(s) mounted between the mounting rod 42 and the bases 41 are made, for example, of metal.

Each of the rods 20 is mounted via a first free end, or fitted, in an orifice formed in one of the respective bases 41, and accommodated by a second free end, or fitted, opposite to the first free end in a respective receiving space formed between the projections 32 on the upper part 15 of the connection device 7.

The rods 20 have a stable position in which they bias the bases 41 and/or the upper part 15 to place the connection device 7 substantially horizontally.

In the above-described railway braking system 2, the forces generated when braking are transmitted by the two main posts 16 and by the additional post 17 to the connection device 7 and in particular to its upper part 15 then to the support 5 of the railway vehicle 1 via the attachment portion 18 of the connection device 7.

In other words, the main posts 16 are not just axes about which the levers 12 are movable in rotation but are also, and above all, the force transmission members.

Furthermore, the main posts 16 are supported by the additional post 17 which, by its arrangement proximate to the attachment portion 18, ensures enough rigidity to the connection device 7 and an optimum transmission of the friction forces towards the attachment portion 18.

It should be noted that the additional post 17 is herein arranged so as to be located in a free space opposite the wheel 3.

The braking action generates braking forces which are therefore transmitted, via the connection device 7, to the anchor member 6 and to the support 5 to which the braking system 2 is connected.

Variants that are not illustrated are set out hereinafter.

The main posts may be provided with a thinned intermediate portion and/or with a thinned upper portion.

The additional post may be devoid of a thinned intermediate portion and/or of a thinned upper portion.

The lower part and/or the upper part may have a constant thickness or zones that are thicker or thinner than others.

The main and/or additional posts may be screwed onto the lower and upper parts, or interlocked, by shrink-fitting or not, or welded, and/or glued and/or riveted, and/or possibly connected in position using radial pins.

The main and/or additional posts may be mounted so as not to be dismountable from one of the lower and upper parts.

The connection device may be provided with several additional posts, offset or aligned with respect to the main posts.

The anchor member may be formed differently, without any base but with a device including an integrated damper member.

The rings of the anchor member may be made entirely of metal or entirely of plastic or of other materials, for example of a composite material, or the anchor member includes one single ring or is devoid of any ring.

The projections defined by substantially vertical walls may be replaced by horizontal grooves, whose bottom is configured to enable prestressing of the rods and an easy assembly of these.

The service and/or parking brake may be electromechanical, or hydraulic, or electrical, or manual rather than pneumatic.

More generally, the invention is not limited to the examples that are described and illustrated.

1. A railway braking system for a railway vehicle (1) with brakes with at least one lining (4), configured to act on at least one braking member (3) of the railway vehicle via the at least one lining and including a connection device (7) having a lower part (14), an upper part (15) distinct from the lower part, two main posts (16) connecting the lower part to the upper part and an attachment portion (18) forming a single anchor zone by which the railway braking system (2) is configured to be mechanically connected to the railway vehicle, the system further including a brake linkage (10) having levers (12) mounted movable in rotation about the two main posts, and a service and/or parking brake (11) configured to act on the braking member by actuation of the levers of the brake linkage; characterised in that the connection device further includes at least one additional post (17) also connecting the lower part to the upper part and which is arranged closer to the attachment portion than the two main posts.

2. The railway braking system according to claim 1, wherein the upper part (15) of the connection device (7) extends generally longitudinally between a first end (21) and a second end (22) opposite to the first end, the main posts (16) are mechanically connected respectively on a first side (23) and on a second side (24) opposite to the first side, at the level of the second end of the upper part, and the attachment portion (18) extends longitudinally over a central zone (25) of the connection device located between the first side and the second side, from the first end towards the second end.

3. The railway braking system according to claim 1, wherein the upper part (15) of the connection device (7) is provided with a first arm (28) extending from a main fastening upper zone (26) of one of the two main posts (16), with a second arm (29) extending from another main fastening upper zone (26) of the other one of the main posts (16), with the first arm and the second arm each joining the attachment portion (18).

4. The railway braking system according to claim 2, wherein the first arm (28) extends from the second end (22) on the first side (23) towards the central zone (25), the second arm (29) extends from the second end on the second side (24) towards the central zone where the attachment portion (18) is located and an additional fastening upper zone (27) of the additional post (17) at the level of the second end.

5. The railway braking system according to claim 1, wherein the lower part (14) of the connection device (7) is generally C-like shaped and is provided with a main fastening lower zone (33) formed at each free end of the C and with an additional fastening lower zone (34) formed at the centre of the C.

6. The railway braking system according to claim 1, wherein the main posts (16) and the at least one additional post (17) are mechanically connected by screwing and/or by interlocking, optionally by shrink-fitting, and/or by welding and/or by gluing to the upper part (15) and/or to the lower part (14) of the connection device (7).

7. The railway braking system according to claim 1, wherein further includes at least one repositioning member (19) substantially elastic and having a first end connected to the upper part (15) and a second end connected to a lining carrier (13) on which at least one said lining (4) is mounted.

8. The railway braking system according to claim 1, wherein the attachment portion (18) of the connection device (7) has at least one cylindrical wall (31) and the railway braking system (2) includes an anchor member (6) formed by at least one base (41) mounted opposite the cylindrical wall, a mounting rod (42) inserted at least partially into the base and into the cylindrical wall, and at least one cylindrical ring (43) mounted between the mounting rod and the base and/or between the mounting rod and the cylindrical wall, with the at least one base being pivotably mounted relative to the attachment portion.

9. The railway braking system according to claim 8, wherein the anchor member (6) is provided with at least one cylindrical ring made for example of metal and mounted between the mounting rod (42) and the base (41) and with at least a cylindrical ring (43) made for example of plastic and mounted between the mounting rod (42) and the cylindrical wall (31).

10. The railway braking system according to claim 8, wherein at least one base (41) is positioned opposite at least one additional fastening upper zone (27) of the additional post (17) which is formed in the upper part (15) of the connection device (7).

11. The railway braking system according to claim 8, wherein the anchor member (6) is provided with at least one return member (20) mounted so as to cooperate with both the at least one base (41) and the upper part (15) of the connection device (7) and having a stable position in which it biases the at least one base to return the connection device back to a predetermined position, for example substantially horizontally.

12. The railway braking system according to claim 11, wherein at least one return member (20) is formed by an elastic rod having a first free end mounted in an orifice formed in the at least one base (41), and a second free end opposite to the first free end and accommodated in a projection (32) formed on the upper part (15) of the connection device (7).

13. A railway vehicle with brakes with at least one lining (4), including at least one railway braking system (2) according to claim 1 configured to act on at least one braking member (3) of said railway vehicle (1) via said at least one lining.
